(19) United States
(12) Patent Application Publication
(10) Pub. No.: US 2020/0169883 A1
(43) Pub. Date: May 28, 2020

(54) Security Detection Method for Physical Layer Authentication System

(71) Applicant: Shenzhen University, Shenzhen (CN)

(72) Inventors: Ning XIE, Shenzhen (CN); Zhuoyuan LI, Shenzhen (CN)

(73) Assignee: Shenzhen University, Shenzhen (CN)

(21) Appl. No.: 16/672,355

(22) Filed: Nov. 1, 2019

(30) Foreign Application Priority Data
Nov. 22, 2018 (CN) 201811401636.1

(51) Int. Cl. H04W 12/06

(52) U.S. Cl. CPC H04W 12/06; G06F 17/18

(57) ABSTRACT

In a method of security detection for a physical layer authentication a transmitter transmits a first signal, which, after passing over a wireless fading channel becomes a second signal. An active adversary receives the second signal and determines a first false alarm probability based. The adversary may determine a first optimal threshold by setting the first false alarm probability less than or equal to an upper bound, and then determine a first detection probability. A receiver device also receives the second signal, extracts an object signal from it, determines a residual signal from the object signal, and a second testing statistic. The receiver may then determine a second optimal threshold and a second detection probability. Based on the first and second detection probabilities, the system may determine a probability of security authentication and thus measure the safety of the physical layer authentication system.

### CROSS-REFERENCE TO RELATED APPLICATIONS

This application claims priority of Chinese application No. 201811401636.1 filed Nov. 22, 2018, for “Security Detection Method for Physical Layer Authentication System”.

### TECHNICAL FIELD

The present disclosure relates to wireless communication technology, in particular, to a security detection method for a physical layer authentication.

### BACKGROUND ART

The ability to verify the authenticity of a transmitter is a fundamental security requirement. Authentication technology is typically based on some encryption mechanism and identity authentication is carried out in the upper layer. Compared with this authentication technology, authentication at the physical layer has two main advantages. First, authentication at the physical layer may achieve higher information theory security by introducing noise to an adversarial device. Second, authentication at the physical layer can avoid any operation of an upper layer, so higher efficiency and better compatibility may be achieved.

Performance evaluation of physical layer authentication technology is mainly based on three characteristics: covertness, security, and robustness. Specifically, covertness may have two aspects: methods for authentication should not be easily detected or observed; and there should be no significant effect on the ability of an unaware receiver to recover the message. Security is the ability to resist attacks by an actively adversarial monitoring device. Robustness is the ability to evaluate whether the authentication technology may be used in interference.

However, research analyzing the performance analysis of physical layer authentication is still imperfect. Because the above three characteristics are usually analyzed separately, it is difficult to systematically analyze the effect of parameters of a certain physical layer authentication scheme on final performance, and it is also difficult to fairly compare the performance of different physical layer authentication schemes under the same channel conditions.

### BRIEF DESCRIPTION OF THE DRAWINGS

FIG. 1 is a schematic scenario diagram of a security detection method for a physical layer authentication system according to some embodiments.

FIG. 2 is a schematic flowchart diagram of a security detection method for a physical layer authentication system according to some embodiments.

FIG. 3 is a schematic waveform diagram showing a security authentication probability of a physical layer authentication system and a signal-to-noise ratio (SNR) at a receiving device of the physical layer authentication system according to some embodiments.

### DETAILED DESCRIPTION

The technical solutions in the embodiments of the present disclosure will be clearly and completely described in the following with reference to the accompanying drawings. It is apparent that the described embodiments are only some of the embodiments of the disclosure, and not all possible embodiments. All other embodiments obtained by those skilled in the art based on the embodiments of the present disclosure without creative efforts are within the scope of the present disclosure.

It should be noted that the terms “first” and “second” and the like in the specification and claims of the present disclosure and the above drawings are used to distinguish different objects, and are not intended to describe a specific order. Furthermore, the terms “comprises” and “comprising” are intended to cover a non-exclusive inclusion. For example, a process, method, system, product, or device that comprises a series of steps or units is not limited to the listed steps or units, but optionally also includes steps or units not listed, or, other steps or units optionally inherent to these processes, methods, products or equipment.

The disclosure discloses a security detection method for a physical layer authentication system that can improve the convenience and accuracy of authentication system performance analysis. The details are described below.

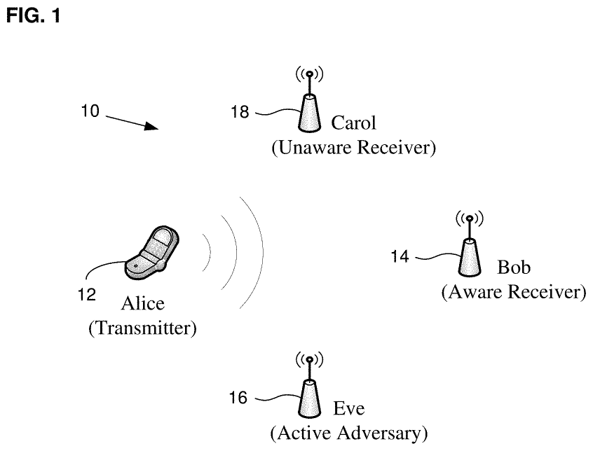

FIG. 1 is a schematic scenario diagram that illustrates some embodiments of a security detection method for a physical layer authentication system. As shown in FIG. 1, the security detection method for this physical layer authentication system may be that of a wireless communication physical authentication system, including an authorized transmitting device 12 (shown as “Alice”), a receiving device 14 (“Bob”), and an active, and adversarial device 16 (the “adversary”, for short, or “Eve”). Here, as is common in the literature, that an adversary is “active” implies that it transmits one or more signals intended to negatively affect one or more authorized systems.

According to some embodiments, as shown in FIG. 1, the security detection method for the physical layer authentication system is based on a general signal transmission scenario 10. The signal transmission scenario includes four users: the transmitting device 12, the receiving device 14, the adversary 16, and an unaware monitoring device 18 (“Carol”). Although only one each is shown in FIG. 1 and described here, the number of transmitting devices, receiving devices, adversaries and monitoring devices could instead be two or more. The transmitting device 12 may transmit a carrier signal to the receiving device 14, and the adversary and the unaware monitoring devices may also receive the carrier signal

According to some embodiments, it is assumed that the transmitting device 12 and the receiving device 14 agree on an authentication scheme with a shared secret key that allows the receiving device 14 to verify a tagged message from the transmitting device 12. Here, as in the prior art, a “tagged” message is one in which a tag is embedded, for example, and may be in the known form of a hash of a secret key and the source message. The unaware monitoring device 18 does not know the authentication scheme between the transmitting device 12 and the receiving device 14. The unaware monitoring device 18 therefore cannot authenticate the tagged signal in the carrier signal; however, the unaware monitoring device 18 could still recover a message signal not secured by the secret key in the carrier signal. The adversary may be aware of the authentication scheme between the transmitting device 12 and the receiving device 14, but the adversary 16 cannot generate the tag, that is, the adversary 16 cannot authenticate the carrier signal.

According to some embodiments, the transmitting device 12, receiving device 14, unaware monitoring device 18, or adversary 16 of the signal transmission scenario shown in FIG. 1 may include a base station or other user equipment. The receiving device 14 may also include test equipment or user equipment. A base station (e.g., an access point or node) may refer to a device in an access network that communicates with a wireless terminal by one or more sectors over an air interface. The base station may convert received air frames to the IP packets as a router between the wireless terminal and the rest of the access network, which may include an Internet Protocol (IP) network. The base station may also coordinate attribute management of the air interface. For example, the base station may be a GSM or CDMA base station (BTS, Base Transceiver Station), or a WCDMA base station (NodeB), or a LTE evolutionary base station (NodeB, eNB, e-NodeB, evolutional NodeB).

According to some embodiments, the user equipment or test equipment may include, but is not limited to, a smart phone, a notebook computer, a personal computer (PC), a personal digital assistant (PDA), a mobile internet device (MID), a wearable device (such as Smart watch, smart bracelet, smart glasses). The operating system of the user device may be, but is not limited to, an Android operating system, an IOS operating system, a Symbian operating system, a BlackBerry operating system and Windows Phone 8 operating system and so on.

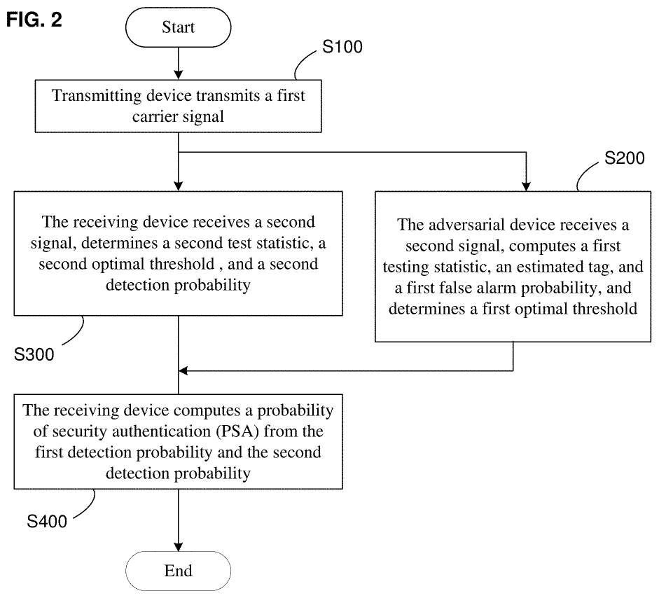

FIG. 2 is a schematic flowchart diagram of some embodiments of a security detection method for a system for physical layer authentication.

According to some embodiments, based on the signal transmission scenario shown in FIG. 1, the security detection method shown in FIG. 2, may include: the transmitting device transmits signal (step S100), to be specific, the transmitting device may transmit a first carrier signal through a wireless fading channel, and then the receiving device, the unaware monitoring device, and the adversary may obtain a second carrier signal respectively. The wireless fading channel may comprise a flat block-fading channel.

In step S100, the first signal may be transmitted in the form of data blocks, which makes it easy to manipulate data. A first signal xᵢ of an i'th block, that is, the first signal xᵢ of each block, is an independent and identically distributed (i.i.d) random variable (RV). The signal length of the first signal xᵢ of the i'th block is L.

According to some embodiments, the first signal may be a normal signal. A normal signal may be a message signal obtained by encoding and modulating an initial signal, which may be represented as xᵢ=sᵢ, where sᵢ denotes the i'th block of message signal. The first signal may also be a tagged signal. The tagged signal may include a message signal and a tag signal, which may be expressed as xᵢ=ρₛ*sᵢ+ρₜ*tᵢ, wherein ρₜ² and ρₛ² may be interpreted as energy allocation factors of the message and tag, respectively, and ρₛ²+ρₜ²=1. When ρₜ²=0, the first signal does not contain any authentication tag and xᵢ=sᵢ, which is defined as a normal signal. Furthermore, tᵢ donates the i'th block of the tag signal, which may be generated by a hash function g(⋅) with a secret key K shared between the transmitting device and the receiving device, which may be expressed as tᵢ=g(sᵢ,K).

According to some embodiments, the transmitting device 12 may control the message signal energy allocations ρₜ² and ρₛ². To be specific, the transmitting device 12 may use automatic power control. For instance, if ratio frequency signals received by the transceiver station of the base station are successively input into a filter and a frequency converter with filtering function, then the system may obtain an IF (intermediate frequency) signal. After that, the IF signal may be input into the automatic power control module of the base station to adjust power. The automatic power control module may include an ADC (analog-to-digital converter), DC-removal unit, a power estimation unit, and a power feedback adjustment unit.

According to some embodiments, a process of automatic power control in the automatic power control module may include several steps: passing an IF signal through the ADC to obtain a digital signal and the passing the digital signal through the DC-removal unit to obtain an estimation of signal power. Then, the estimation of signal power is passed through the power feedback adjustment unit to obtain a gain coefficient. The gain coefficient is applied to a process of limiting adjustment in the next period of time, and finally an output of the digital IF signal may be maintained near the stable power.

According to some embodiments, the transmitting device may stabilize the received signal by the automatic power controlling process described above, and then send it transmit it. The method may effectively reduce or avoid the communication signal loss in wireless transmission, and ensure the communication quality of user equipment.

In step S100, the first signal is passed through the wireless fading channel, and the receiving device, the unaware monitoring device, and the adversary may obtain the second signal. Different data blocks of the first signal may fade independently when passing through the wireless fading channel. An i'th block of second carrier signal may be expressed as

yᵢ=hᵢ*xᵢ+nᵢ (1)

where hᵢ is a channel response, which is a zero-mean complex Gaussian RV with variance σₕ², and nᵢ is a zero-mean complex Gaussian white noise with variance σₙ²

According to some embodiments, as shown in FIG. 2, the security detection method may include step S200. This may include computing a first false alarm probability based on a received second signal, computing a first optimal threshold from the first false alarm probability, and determining a first detection probability. In the step S200, to be specific, the adversary may receive the second signal, compute a first testing statistic and an estimated tag based on the second signal, compute a first false alarm probability base on a first test hypothesis and the first test statistic, and, based on the Neyman-Pearson theorem, determine a first optimal threshold if the first false alarm probability is less than or equal to an upper bound of the first false alarm probability.

In step S200, the adversary may be assumed to receive the second signal. The SNR (signal-to-noise ratio) γᵢ of the second signal yᵢ of the i'th block of the second signal yᵢ may be donated as γᵢ=|hᵢ|²/σₕ². The adversary may be assumed to estimate an i'th block of an object signal using its channel estimation ĥᵢ. The object signal may be denoted as

$${\hat{x}}_{i} = \frac{{\hat{h}}_{i}^{*}}{{\vert {\hat{h}}_{i} \vert}^{2}} {y}_{i} \qquad ( 2 )$$

where ( )* represents the conjugate-taking operation. Here, to simplify the analysis, assume that the adversary has perfect channel estimation, i.e., ĥᵢ=hᵢ. Then, by sequential demodulation and decoding, the adversary may be able to determine the source message signal for the object, that is, the message signal.

In step S200. the adversary may obtain the first testing statistic based on the second signal. To be specific, the adversary constructs the first test statistic δ_{i,Eve} by match-filtering the residual. The first testing statistic may be calculated as

δ_{i,Eve}=R{τ_{i,Eve}}=R{sᵢ^{H}sᵢ−\hat{x}ᵢ^{H}sᵢ}=R{(sᵢ^{H}−\hat{x}ᵢ^{H})sᵢ} (3)

where R{⋅} represents the operation of extracting the real part, superscript H indicates the Hermitian transpose, τ_{i,Eve} donates the first initial test statistic and \hat{x}ᵢ is defined in (2). There are two reasons for calculating the testing statistic δ_{i,Eve} using the correlation operation. First, the correlation between \hat{x}ᵢ and sᵢ explicitly quantifies how much space of the normal signal is occupied by the authentication tag for a physical layer authentication scheme, i.e., the lower the correlation value is, the more the normal signal space is occupied. Second, the testing statistic using the correlation operation may provide tractable closed-form results for existing physical layer authentication schemes. In other embodiments, using the test statistic may provide a new physical layer authentication system scheme.

According to some embodiments, based on the first testing hypothesis, the adversary may determine whether the second signal contains the authenticated signal. The first testing hypothesis may be expressed as:

H₁₀: the second carrier signal is a normal signal
H₁₁: the second carrier signal is a tagged signal.
In addition, the first optimal threshold θ_{i,Eve} of i'th block may be determined based on the first testing hypothesis.

According to some embodiments, the first testing statistic τ_{i,Eve} for the different hypotheses may be respectively expressed by two formulas:

τ_{i,Eve}|H₁₀=sᵢ^{H}sᵢ−sᵢ^{H}sᵢ−v_{i,Eve}=−v_{i,Eve}, and

τ_{i,Eve}|H₁₁=(1−ρₛ)sᵢ^{H}sᵢ−ρₜtᵢ^{H}sᵢ−v_{i,Eve},

where v_{i,Eve}=(h_{i,Eve}*/h_{i,Eve}|²)sᵢ^{H}n_{i,Eve} is a random variate with zero-mean Gaussian RV, with variance σᵥ_{_{i,Eve}}²=Lσ_{n,Eve}²/|h_{i,Eve}|²=L/γ_{i,Eve}, and γ_{i,Eve}=|h_{i,Eve}|²/σ_{n,Eve}², where h_{i,Eve} represents the i'th block channel response of the adversary, γ_{i,Eve} represents the i'th block SNR of the adversary by estimating a position of the adversary, and σ_{n,Eve}² represents the variance of noise at the adversary. Because E{τ_{i,Eve}|H₁₀}=0 and var{τ_{i,Eve}|H₁₀}=L/γ_{i,Eve}, the first testing statistic under the condition H₁₀ should follow a distribution, i.e., τ_{i,Eve}|H₁₀˜CN(0,L/g_{i,Eve}). At the same time, because E{τ_{i,Eve}|H₁₁}=(1−ρₛ)L and var{τ_{i,Eve}|H₁₁}=L/γ_{i,Eve}, the first testing statistic under a condition H₁₁ should follow a distribution, i.e., τ_{i,Eve}|H₁₁˜CN((1−rₛ)L, L/g_{i,Eve}). Then, because δ_{i,Eve}=R{τ_{i,Eve}}, the first testing hypothesis may be transformed into

$${H}_{10} \text{:} {δ}_{i , Eve} \sim N ( 0 , \frac{L}{2 {γ}_{i , Eve }} ) \\ {H}_{11} \text{:} {δ}_{i , Eve} \sim N ( ( 1 - {ρ}_{s} ) L , \frac{L}{2 {γ}_{i , Eve}} ) \qquad ( 4 )$$

According to some embodiments, the adversary may obtain the first false alarm probability from the first testing hypothesis (4) and the first testing statistic. To be specific, the adversary may obtain the i'th block of the first test threshold θ_{i,Eve} based on the first testing hypothesis. Based on the i'th block of the first test threshold θ_{i,Eve}, the first testing statistic and the first testing hypothesis (4), the first false alarm probability P_{FA,i,Eve} of the i'th block may be expressed as

$$\begin{matrix}{P}_{FA , i , Eve} = Pr \{ {δ}_{i , Eve} > {θ}_{i , Eve} \vert {H}_{10} \} \\ = Q ( \frac{{θ}_{i , Eve}}{\sqrt{var \{ {δ}_{i , Eve} \vert {H}_{10} \}}} ) \\ = Q ( {θ}_{i , Eve} \sqrt{\frac{2 {γ}_{i , Eve}}{L}} )\end{matrix} \qquad ( 5 )$$

where γ_{i,Eve} represents the i'th block SNR of the adversary by estimating the position of the adversary, and δ_{i,Eve} represents the first testing statistic of the i'th block. Thus, the first false alarm probability may thereby be determined.

According to some embodiments, h_{i,Eve} may follow a zero-mean complex Gaussian RV, and |hᵢ|² is an exponential RV. Based on

$$\frac{1}{b} {\int }_{0}^{∞} Q ( \sqrt{x} ) exp ( \frac{- x}{b} ) dx = \frac{1}{2} ( 1 - \sqrt{\frac{b}{2 + b}} ) ,$$

the first false alarm probability may be obtained by computing the mean of all data blocks, which may be calculated

$${P}_{FA , Eve} = E \{ Q ( \sqrt{\frac{2 {( {θ}_{Eve}^{0} )}^{2} {\vert {h}_{i , Eve} \vert}^{2}}{L {σ}_{n , Eve}^{2}}} ) \} \\ \begin{matrix}by = \frac{1}{{σ}_{h , Eve}^{2}} {\int }_{0}^{∞} Q ( \sqrt{\frac{2 {( {θ}_{Eve}^{0} )}^{2} y}{L {σ}_{n , Eve}^{2}}} ) exp ( \frac{- y}{{σ}_{h , Eve}^{2}} ) dy \\ = \frac{1}{2} ( 1 - \sqrt{\frac{{( {θ}_{Eve}^{0} )}^{2} {γ}_{Eve}}{L + {( {θ}_{Eve}^{0} )}^{2} {γ}_{Eve}}} )\end{matrix} \qquad ( 6 )$$

where γ_{Eve}=E(γ_{i,Eve}) represent the SNR of the adversary by estimating the position of suspicious nodes, i.e. the adversary.

In step S200, based on the Neyman-Pearson theorem, the adversary may obtain the first optimal threshold when the first false probability is less than or equal to the upper bound of the first false probability, and then the first detection probability may be determined.

According to some embodiments, based on the Neyman-Pearson theorem, the first false probability P_{EA,Eve} is satisfied if P_{FA,Eve}≤ε_{PFA,Eve}, where ε_{PFA,Eve} denotes the upper bound of the first false probability. Thus, it is possible to ensure that the first false probability is less than or equal to the upper bound of the first false probability, and a maximum of the first detect probability may be determined.

According to some embodiments, when P_{FA,Eve}≤ε_{PFA,Eve}, the first false probability is set equal to the upper bound of the first false probability ε_{PFA,Eve}; after that, the first optimal threshold θ_{Eve}⁰ may be computed as

$${θ}_{Eve}^{0} = \sqrt{\frac{{( 1 - 2 {ɛ}_{PFA , Eve} )}^{2} L}{4 ( {ɛ}_{PFA , Eve} - {ɛ}_{PFA , Eve}^{2} ) {γ}_{Eve}}}$$

where L donates a signal length of each block of the first signal. To be specific, γ_{Eve} may be determined by estimating the position of suspicious nodes, i.e., the adversary. The first optimal threshold may thereby be determined.

According to some embodiments, the adversary may determine the first detection probability by using the first optimal threshold. To be specific, the first detect probability of the i'th block may be expressed as

$$\begin{matrix}{P}_{D , i , Eve} = Pr \{ {δ}_{i , Eve} > {θ}_{Eve}^{0} \vert {H}_{11} \} \\ = Q ( \frac{{θ}_{Eve}^{0} - ( 1 - {ρ}_{s} ) L}{\sqrt{var \{ {δ}_{i , Eve} \vert {H}_{11} \}}} ) \\ = \{ \begin{matrix}Q ( \sqrt{\frac{2 {( {θ}_{Eve}^{0} - ( 1 - {ρ}_{s} ) L )}^{2} {γ}_{i , Eve}}{L}} ) , & {θ}_{Eve}^{0} \geq ( 1 - {ρ}_{s} ) L \\ 1 - Q ( \sqrt{\frac{2 {( {θ}_{Eve}^{0} - ( 1 - {ρ}_{s} ) L )}^{2} {γ}_{i , Eve}}{L}} ) , & {θ}_{Eve}^{0} < ( 1 - {ρ}_{s} ) L\end{matrix}\end{matrix} \qquad ( 7 )$$

whereby the first detection probability may be obtained.

According to some embodiments, the first detection probability may be computed by taking an average of all data blocks, which may be computed by

$$\begin{matrix}{P}_{D , Eve} = E \{ Pr \{ {δ}_{i , Eve} > {θ}_{Eve}^{0} \vert {H}_{1} \} \} \\ = \{ \begin{matrix}\frac{1}{2} ( 1 - \sqrt{\frac{{( {θ}_{Eve}^{0} - ( 1 - {ρ}_{s} ) L )}^{2} {γ}_{Eve}}{L + {( {θ}_{Eve}^{0} - ( 1 - {ρ}_{s} ) L )}^{2} {γ}_{Eve}}} ) , & {θ}_{Eve}^{0} \geq ( 1 - {ρ}_{s} ) L \\ \frac{1}{2} ( 1 + \sqrt{\frac{2 {( {θ}_{Eve}^{0} - ( 1 - {ρ}_{s} ) L )}^{2} {γ}_{Eve}}{L + {( {θ}_{Eve}^{0} - ( 1 - {ρ}_{s} ) L )}^{2} {γ}_{Eve}}} ) , & {θ}_{Eve}^{0} < ( 1 - {ρ}_{s} ) L\end{matrix} .\end{matrix} \qquad ( 8 )$$

In summary

$${P}_{D , Eve} = \frac{1}{2} ( 1 - sign ( {θ}_{Eve}^{0} - ( 1 - {ρ}_{s} ) L ) \sqrt{\frac{{( {θ}_{Eve}^{0} - ( 1 - {ρ}_{s} ) L )}^{2} {γ}_{Eve}}{L + {( {θ}_{Eve}^{0} - ( 1 - {ρ}_{s} ) L )}^{2} {γ}_{Eve}}} ) \qquad ( 9 )$$

According to some embodiments, as shown in FIG. 2, the security detection method may include step S300, which comprises obtaining a second false alarm probability based on the received signal; obtaining a second optimal threshold based on the second false alarm probability; and computing a second detection probability. In step S300, to be specific, the receiving device may receive a second signal, determine an object signal based on the second signal; determine a residual signal based on the object signal; and determine a second test statistic based on the residual signal. Based on the Neyman-Pearson theorem, the receiving device may then determine a second optimal threshold if the second false alarm probability is less than or equal to an upper bound of the second false alarm probability; the second detection probability may then be determined.

In step S300, the receiving device may obtain the object carrier signal from the second signal. To be specific, after estimating the channel, the receiving device may use its channel estimation ĥᵢ to estimate the i'th block of the object carrier signal according to (2) above.

According to some embodiments, the receiving device may determine a residual signal based on the object signal. To be specific, the receiving device may compute the residual signal of the i'th block of rᵢ based on the object signal of the i'th block. The residual signal of the i'th block rᵢ may be constructed as

$${r}_{i} = \frac{1}{{ρ}_{t}} ( {\hat{x}}_{i} - {ρ}_{s} {\hat{s}}_{i} ) \qquad ( 10 )$$

According to some embodiments, the receiving device may determine the second testing statistic δ_{i,Bob} by match-filtering the residual with the estimated tag and taking its real part, which is expressed as

δ_{i,Bob}=R{τ_{i,Bob}}=R{tᵢ^{H}rᵢ} (11)

where τ_{i,Bob} donates the initial second testing statistic.

According to some embodiments, based on the second testing hypothesis, the receiving device may determine whether the second signal contains the authenticated signal, which may save computing resources. The second testing hypothesis may be expressed as

H₂₀: the tag signal is not present in the residual signal
H₂₁: the tag signal is present in the residual signal
In addition, the second optimal threshold θ_{i,Bob} of the i'th block may be determined based on the second testing hypothesis, after which the second false alarm probability may be computed.

According to some embodiments, the second testing statistic τ_{i,Bob} for two different hypotheses may be respectively expressed by two formula:

$${τ}_{i , Bob} \vert {H}_{20} = \frac{1}{{ρ}_{t} } ( ( 1 - {ρ}_{s} ) {\sum }_{k = 1}^{L} {t}_{i , k}^{*} {s}_{i , k} + \frac{{h}_{i}^{*}}{{\vert {h}_{i} \vert}^{2}} {\sum }_{k = 1}^{L} {t}_{i , k}^{*} {n}_{i , k} ) , and$$

$${τ}_{i , Bob} \vert {H}_{21} = \frac{1}{{ρ}_{t}} ( {ρ}_{t} {\sum }_{k = 1}^{L} {t}_{i , k}^{*} {t}_{i , k} + \frac{{h}_{i}^{*}}{{\vert {h}_{i} \vert}^{2}} {\sum }_{k = 1}^{L} {t}_{i , k}^{*} {n}_{i , k} ) ,$$

where E{τ_{i,Bob}|H₂₀}=0, var{τ_{i,Bob}|H₂₀}=L/ρₜ²γ_{i,Bob}, γ_{i,Bob}=|h_{i,Bob}|²/σ_{n,Bob}² represent the SNR of the i'th block at the receiving device. The second testing statistic under the condition H₂₀ should follow a distribution, i.e., t_{i,Bob}|H₂₀˜CN(0,L/rₜ²g_{i,Bob}). Due to E{τ_{i,Bob}|H₂₁}=L and var{τ_{i,Bob}|H₂₁}=L/ρₜ²γ_{i,Bob}, the second testing statistic under the condition H₂₀ should follow a distribution, i.e., t_{i,Bob}|H₂₁˜CN(L,L/rₜ²g_{i,Bob}). Then the second testing hypothesis may be transformed into

$${H}_{20} \text{:} {δ}_{i , Bob} \sim N ( 0 , \frac{L}{2 {ρ}_{t}^{2} {γ}_{i , Bob}} ) \\ {H}_{21} \text{:} {δ}_{i , Bob} \sim N ( L , \frac{L}{2 {ρ}_{t}^{2} {γ}_{i , Bob}} ) \qquad ( 12 )$$

According to some embodiments, the receiving device may determine the second false alarm probability based on the second testing hypothesis and the second testing statistic. To be specific, the receiving device may determine the second test threshold θ_{i,Bob} of the i'th block based on the second testing hypothesis. Based on the second test threshold θ_{i,Bob} of the i'th block, the second testing statistic, and the second testing hypothesis, the second false alarm probability P_{FA,i,Bob} of the i'th block may be computed, which may be expressed as

$$\begin{matrix}{P}_{FA , i , Bob} = Pr \{ {δ}_{i , Bob} > {θ}_{i , Bob} \vert {H}_{20} \} \\ = Q ( \frac{{θ}_{i , Bob}}{\sqrt{var \{ {δ}_{i , Bob} \vert {H}_{20} \}}} ) \\ = Q ( \sqrt{\frac{2 {θ}_{i , Bob}^{2} {ρ}_{t}^{2} {γ}_{i , Bob}}{L}} )\end{matrix} \qquad ( 13 )$$

where γ_{i,Bob} represents the i'th block SNR of the receiving device, δ_{i,Bob} represents the second testing statistic of the i'th block. The second false alarm probability may be computed.

According to some embodiments, the second false alarm probability may be computed as the mean of all data blocks, which may be calculated by

$$\begin{matrix}{P}_{FA , Bob} = E \{ Q ( \sqrt{\frac{{( {θ}_{Bob}^{0} )}^{2} 2 {ρ}_{t}^{2} {γ}_{i , Bob}}{L}} ) \} \\ = \frac{1}{2} ( 1 - \sqrt{\frac{{( {θ}_{Bob}^{0} )}^{2} {ρ}_{t}^{2} {γ}_{Bob }}{L + {( {θ}_{Bob}^{0} )}^{2} {ρ}_{t}^{2} {γ}_{Bob}}} )\end{matrix} \qquad ( 14 )$$

where γ_{Bob}=E(γ_{i,Bob}) represents the SNR of the receiving device.

In step S300, based on the Neyman-Pearson theorem, the receiving device may determine the second optimal threshold when the second false probability is less than or equal to the upper bound of the second false probability, and then the second detection probability may be determined. The authentication accuracy may be determined from the second detection probability.

According to some embodiments, based on the Neyman-Pearson theorem, the second false probability P_{FA,Bob} is satisfied when P_{FA,Bob}≤ε_{PFA,Bob}, where ε_{PFA,Bob} donates the upper bound of the second false probability. Thus, the second false probability may be ensured to be less than or equal to the upper bound of the second false probability, with a maximum equal to second detection probability.

According to some embodiments, when P_{FA,Bob}≤ε_{PFA,Bob}, the system may set the second false probability equal to the upper bound of the second false probability ε_{PFA,Bob}, after which the second optimal threshold θ_{Bob}⁰ may be computed as

$${θ}_{Bob}^{0} = \sqrt{\frac{{( 1 - 2 {ɛ}_{PFA , Bob} )}^{2} L}{4 ( {ɛ}_{PFA , Bob} - {ɛ}_{PFA , Bob}^{2} ) {ρ}_{t}^{2} {γ}_{Bob}}} ,$$

where L donates the signal length of each block of second signal, γ_{Bob} donates the SNR at the receiving device, and ρₜ² donates the energy allocation of tag signal. Thus, one may determine the second optimal threshold.

According to some embodiments, the receiving device may determine the second detection probability using the second optimal threshold. To be specific, the receiving device may determine the second detection probability based on the second testing statistic and the second optimal threshold. The i'th block of the second detection probability may be expressed as

$$\begin{matrix}{P}_{D , i , Bob} = Pr \{ {δ}_{i , Bob} > {θ}_{i , Bob} \vert {H}_{21} \} \\ = Q ( \frac{{θ}_{i , Bob} - L}{\sqrt{var \{ {δ}_{i , Bob} \vert {H}_{21} \}}} ) \\ = \{ \begin{matrix}Q ( \sqrt{\frac{2 {( {θ}_{i , Bob} - L )}^{2} {ρ}_{t}^{2} {γ}_{i , Bob}}{L}} ) & {θ}_{i , Bob} \geq L \\ 1 - Q ( \sqrt{\frac{2 {( {θ}_{i , Bob} - L )}^{2} {ρ}_{t}^{2} {γ}_{i , Bob}}{L}} ) & {θ}_{i , Bob} < L\end{matrix}\end{matrix} \qquad ( 15 )$$

From this, the second detection probability may be determined.

According to some embodiments, the second detection probability may be computed by taking the average of all data blocks, which may be expressed by

$$\begin{matrix}{P}_{D , Bob} = E \{ Pr \{ {δ}_{i , Bob} > {θ}_{i , Bob} \vert {H}_{21} \} \} \\ = \{ \begin{matrix}\frac{1}{2} ( 1 - \sqrt{\frac{{( {θ}_{Bob}^{0} - L )}^{2} {ρ}_{t}^{2} {γ}_{Bob}}{L + {( {θ}_{Bob}^{0} - L )}^{2} {ρ}_{t}^{2} {γ}_{Bob}}} ) , & {θ}_{Bob}^{0} \geq L \\ \frac{1}{2} ( 1 + \sqrt{\frac{{( {θ}_{Bob}^{0} - L )}^{2} {ρ}_{t}^{2} {γ}_{Bob}}{L + {( {θ}_{Bob}^{0} - L )}^{2} {ρ}_{t}^{2} {γ}_{Bob}}} ) , & {θ}_{Bob}^{0} < L\end{matrix}\end{matrix} \qquad ( 16 )$$

In summary

$${P}_{D , Bob} = \frac{1}{2} ( 1 - sign ( {θ}_{Bob}^{0} - L ) \sqrt{\frac{{( {θ}_{Bob}^{0} - L )}^{2} {ρ}_{t}^{2} {γ}_{Bob}}{L + {( {θ}_{Bob}^{0} - L )}^{2} {ρ}_{t}^{2} {γ}_{Bob}}} ) \qquad ( 17 )$$

According to some embodiments, as shown in FIG. 2, the security detection method for physical layer authentication system may obtain the probability of security authentication (PSA) based on the first detection probability and the second detection probability. To be specific, in step S

400, the receiving device may compute the PSA from the first detection probability and the second detection probability, which may be used to estimate the security of physical layer authentication system.

In step S400, the PSA may be expressed as

P_{SA}=max{P_{D,Bob}−P_{D,Eve},0} (18)

where P_{D,Eve} donates the first detection probability, and P_{D,Bob} donates the second detection probability. The PSA may be written as

$$\begin{matrix}{P}_{SA} = max \{ {P}_{D , Bob} - {P}_{D , Eve} , 0 \} \\ = max \{ [ \begin{matrix}\frac{1}{2} ( 1 - sign ( {θ}_{Bob}^{0} - L ) \sqrt{\frac{{( {θ}_{Bob}^{0} - L )}^{2} {ρ}_{t}^{2} {γ}_{Bob}}{L + {( {θ}_{Bob}^{0} - L )}^{2} {ρ}_{t}^{2} {γ}_{Bob}}} ) - \\ \frac{1}{2} ( \begin{matrix}1 - sign ( {θ}_{Eve}^{0} - ( 1 - {ρ}_{s} ) L ) \\ \sqrt{\frac{{( {θ}_{Eve}^{0} - ( 1 - {ρ}_{s} ) L )}^{2} {γ}_{Eve}}{L + {( {θ}_{Eve}^{0} - ( 1 - {ρ}_{s} ) L )}^{2} {γ}_{Eve}}}\end{matrix} )\end{matrix} ] , 0 \}\end{matrix} \qquad ( 19 )$$

The PSA may thus be determined.

According to some embodiments, based on the Neyman-Pearson theorem, the probability of security authentication (PSA) should be satisfied if the first false alarm probability is less than or equal to the upper bound of the first false alarm probability and the second false alarm probability is less than or equal to the upper bound of the second false alarm probability. Mathematically, the optimization problem may be expressed as

$${P}_{SA} = max \{ {η}_{Bob} - {η}_{Eve} , 0 \}$$

$$subject to \begin{matrix}{P}_{FA , Bob} \leq {ɛ}_{PFA , Bob} \\ {P}_{FA , Eve} \leq {ɛ}_{PFA , Eve}\end{matrix}$$

Based on this formulation, the security of the physical layer authentication system may be analyzed simultaneously.

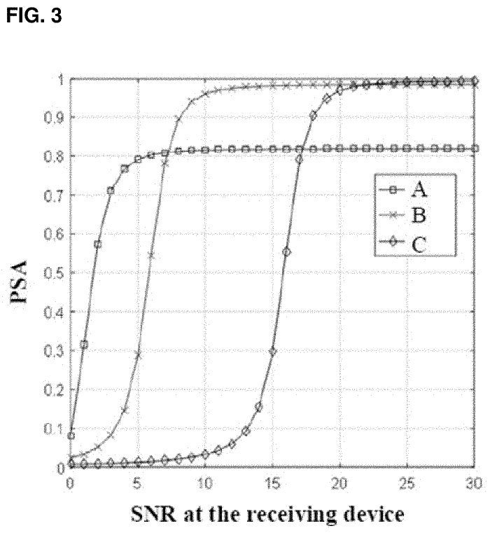

FIG. 3 is a schematic waveform diagram of the ratio of security authentication probability and the signal-to-noise ratio (SNR) at the receiving device under the condition of different energy allocation factors in to some embodiments.

In some embodiments, as shown in FIG. 3, curves A, B, C are obtained under the conditions that ρₛ² equals 0.7, 0.9, and 0.99, respectively. The horizontal axis represents the SNR at the receiving device and the vertical axis represents the security authentication probability (PSA). FIG. 3 shows that ρₛ²=0.9 is the best option among the three cases, whereas the PSA performance deteriorates when ρₛ² either increases or decreases. Thus, performance of the system could be improved by adjusting the energy allocation factor ρₛ².

In this disclosure, the receiving device's SNR and the adversary's SNR may be determined by distances between their locations and the transmitting device. If the transmitting device is made aware of the adversary coming closer, the transmitting device assesses the security level through the proposed security model. If the transmitting device finds the security level below some threshold, a wise option for the transmitting device is to adjust its authentication parameters, or even to cancel this authentication request to await an appropriate chance.

In this disclosure, the transmitting device transmits the first signal, and the second signal may be obtained by means of first signal passing through the wireless fading channel. The adversary may receive the second signal, obtain the first false alarm probability and the first testing statistic. Based on the Neyman-Pearson theorem, the adversary may determine the first optimal threshold while making the first false alarm probability less than or equal to the upper bound of the first false alarm probability. Finally, the first detection probability may be determined. The receiving device may receive the second signal, obtain the object signal based on the second signal, determine the residual signal from the object signal, and compute the second testing statistic from the residual signal. Based on the Neyman-Pearson theorem, the receiving device may determine the second optimal threshold while making the second false alarm probability less than or equal to the upper bound of the second false alarm probability. Finally, the second detection probability may be computed. Based on the first detect probability and the second detection probability, the PSA may be determined, from which to detect the security of the physical layer authentication system to measure its safety. This may improve the convenience and accuracy of performance analysis.

A computer-readable storage medium is exposed in some embodiments. One of ordinary skill in the art will appreciate that all or part of the various steps of the above-described embodiments may be accomplished by a program instructing the associated hardware. The program may be stored in a computer readable memory, and the memory may include: a flash disk, a read-only memory (ROM), a random access memory (RAM), disk or CD, etc.

A security detection method for a physical layer authentication system for various embodiments is described in detail above. The principles and embodiments of the disclosure have been described herein with reference to specific examples, and the description of the above embodiments is only to assist in understanding the method of the disclosure and its core idea. At the same time, for the general technician in this field, there will be some changes in the specific implementation and application scope according to the idea of this disclosure. In summary, the contents of this specification should not be understood as a limitation to the disclosure.

What is claimed is:

1. A security detection method for a physical layer authentication system including a transmitting device, a receiving device, an active adversary system and an unaware monitoring device, comprising:
a) said transmitting device transmitting a first signal, said first signal passing through a wireless fading channel and becoming a second signal;
b) said active adversary
i) receiving the second signal;
ii) computing a first testing statistic and an estimated tag based on the second signal;
iii) determining a first false alarm probability estimate from the first testing statistic and a first testing hypothesis;
iv) determining a first optimal threshold while making the first false alarm probability less than or equal to an upper bound of the first false alarm probability based on the Neyman-Pearson theorem;
v) determining a first detection probability;
c) said receiving device
i) receiving the second signal;
ii) determining an object signal from the second signal;
iii) determining a residual signal based on the object signal;
iv) computing a second testing statistic based on the residual signal;
v) determining a second optimal threshold while making the second false alarm probability less than or equal to an upper bound of the second false alarm probability based on the Neyman-Pearson theorem;
d) said receiving device further determining a probability of security authentication for measuring safety of the physical layer authentication system based on the first detection probability and the second detection probability.

2. The security detection method of claim 1, further comprising computing the probability of security authentication (PSA) as:
P_{SA}=max{P_{D,Bob}−P_{D,Eve},0}
where P_{D,Eve} is the first detect probability, and P_{D,Bob} is the second detection probability.

3. The security detection method of claim 1, further comprising transmitting the first signal as data blocks.

4. The security detection method of claim 1, further comprising generating an i'th block of the residual signal rᵢ such that
$${r}_{i} = \frac{1}{{ρ}_{t}} ( {\hat{x}}_{i} - {ρ}_{s} {\hat{s}}_{i} )$$
where \hat{x}ᵢ denotes the i'th block of the object signal, ŝᵢ donates the i'th block of the object message signal, and ρₛ²+ρₜ²=1.

5. The security detection method of claim 4, further comprising generating an i'th block of the first testing statistic δ_{i,Eve} such that
δ_{i,Eve}=R{(sᵢ^{H}−\hat{x}ᵢ^{H})sᵢ}
where superscript H denotes the Hermitian transpose, and generating an i'th block of the second testing statistic δ_{i,Bob} such that
δ_{i,Bob}=R{tᵢ^{H}rᵢ}
where tᵢ denotes an i'th block of the tag signal.

6. The security detection method of claim 1, wherein the first testing hypothesis is:
H₁₀: the second carrier signal is a normal signal
H₁₁: the second carrier signal is a tagged signal
and a second testing hypothesis is
H₂₀: the tag signal is not present in the residual signal
H₂₁: the tag signal is present in the residual signal.

7. The security detection method of claim 6, further comprising:
determining an i'th block of a first optimal threshold θ_{i,Eve} based on the first testing hypothesis; and
determining an i'th block of a second optimal threshold θ_{i,Eve} based on the second testing hypothesis.

8. The security detection method of claim 7, further comprising:
computing an i'th block of the first false alarm probability (P_{FA,I,Eve}) such that P_{FA,I,Eve}=Pr{δ_{i,Eve}>θ_{i,Eve}|H₁₀}, as a function of the first optimal threshold θ_{i,Eve} and the i'th block of the first testing hypothesis θ_{i,Eve}; and computing an i'th block of the second false alarm probability (P_{FA,I,Bob}) such that P_{FA,I,Bob}=Pr{δ_{i,Bob}>θ_{i,Bob}|H₂₀}, as a function of the second optimal threshold θ_{i,Bob} and the i'th block of the first testing hypothesis δ_{i,Bob}.

9. The security detection method of claim 8, further comprising
choosing the first optimal threshold θ_{Eve}⁰ by setting the first false alarm probability P_{EA,Eve} as a function of an upper bound of the first false alarm probability, and setting θ_{Eve}⁰ as
$${θ}_{Eve}^{0} = \sqrt{\frac{{( 1 - 2 {ɛ}_{PFA , Eve} )}^{2} L}{4 ( {ɛ}_{PFA , Eve} - {ɛ}_{PFA , Eve}^{2} ) {γ}_{Eve}}} ;$$
and
choosing the second optimal threshold θ_{Bob}⁰ by setting the second false alarm probability P_{FA,Bob} equal to an upper bound of the second false alarm probability, and setting θ_{Bob}⁰ as
$${θ}_{Bob}^{0} = \sqrt{\frac{{( 1 - 2 {ɛ}_{PFA , Bob} )}^{2} L}{4 ( {ɛ}_{PFA , Bob} - {ɛ}_{PFA , Bob}^{2} ) {ρ}_{t}^{2} {γ}_{Bob}}} ;$$
where L donates a signal length of each block of the second signal, where γ_{Eve} is a signal-to-noise ratio (SNR) at the adversarial system, γ_{Bob} is the SNR at the receiving device, ρₜ² donates an energy allocation of the tag signal, ε_{PFA,Eve} donates the upper bound of the first false probability, and ε_{PFA,Eve} donates the upper bound of the second false probability.

10. The security detection method of claim 9, further comprising
determining the i'th block of the first detection probability P_{D,i,Eve} as a function of the first testing statistic and the first optimal threshold, where P_{D,i,Eve} is
$$\begin{matrix}{P}_{D , i , Eve} = Pr \{ {δ}_{i , Eve} > {θ}_{Eve}^{0} \vert {H}_{11} \} \\ = Q ( \frac{{θ}_{Eve}^{0} - ( 1 - {ρ}_{s} ) L}{\sqrt{var ( {δ}_{i , Eve} \vert {H}_{11} \}}} ) \\ = \{ \begin{matrix}Q ( \sqrt{\frac{2 {( {θ}_{Eve}^{0} - ( 1 - {ρ}_{s} ) L )}^{2} {γ}_{i , Eve}}{L}} ) , & {θ}_{Eve}^{0} \geq ( 1 - {ρ}_{s} ) L \\ 1 - Q ( \sqrt{\frac{2 {( {θ}_{Eve}^{0} - ( 1 - {ρ}_{s} ) L )}^{2} {γ}_{i , Eve}}{L}} ) , & {θ}_{Eve}^{0} < ( 1 - {ρ}_{s} ) L\end{matrix} ;\end{matrix}$$
determining the i'th block of the second detection probability P_{D,i,Bob} as a function of the second testing statistic and the second optimal threshold, where P_{D,i,Bob} is
$$\begin{matrix}{P}_{D , i , Bob} = Pr \{ {δ}_{i , Bob} > {θ}_{i , Bob} \vert {H}_{21} \} \\ = Q ( \frac{{θ}_{i , Bob} - L}{\sqrt{var ( {δ}_{i , Bob} \vert {H}_{21} \}}} ) \\ = \{ \begin{matrix}Q ( \sqrt{\frac{2 {( {θ}_{i , Bob} - L )}^{2} {ρ}_{t}^{2} {γ}_{i , Eve}}{L}} ) & {θ}_{i , Bob} \geq L \\ 1 - Q ( \sqrt{\frac{2 {( {θ}_{i , Bob} - L )}^{2} {ρ}_{t}^{2} {γ}_{i , Eve}}{L}} ) & {θ}_{i , Bob} < L\end{matrix} .\end{matrix}$$
where, ρₛ²+ρₜ²=1, γ_{i,Eve} represents the i'th block SNR of the active adversarial system, and γ_{i,Bob} represents the i'th block SNR of the receiving device.
